(19) United States
(12) Patent Application Publication
(10) Pub. No.: US 2026/0204742 A1
(43) Pub. Date: Jul. 16, 2026

(54) CLAMPED BATTERY CONNECTIONS

(71) Applicant: GM GLOBAL TECHNOLOGY OPERATIONS LLC, Detroit, MI (US)

(72) Inventors: John Christian Kalil, Washington, MI (US); Junjie Ma, Novi, MI (US)

(73) Assignee: GM GLOBAL TECHNOLOGY OPERATIONS LLC, Detroit, MI (US)

(21) Appl. No.: 19/019,754

(22) Filed: Jan. 14, 2025

(51) Int. Cl. H01M 50/528; H01M 50/103; H01M 50/15; H01M 50/249; H01M 50/531; H01M 50/566

(52) U.S. Cl. CPC H01M 50/528; H01M 50/15; H01M 50/249; H01M 50/531; H01M 50/566; H01M 50/103

(57) ABSTRACT

Battery assemblies, vehicles with battery assemblies, and methods for manufacturing batteries are provided. A method for manufacturing a battery includes providing a stack of electrodes, wherein each electrode is electrically connected to a foil; clamping first electrode foils with a first clamp; laser welding the first electrode foils to the first clamp; locating a cap plate over the first clamp; and laser welding the cap plate to the first clamp.

### INTRODUCTION

The disclosure relates generally to an assembly strategy for batteries, and more particularly to batteries and methods that provide for clamping and welding electrode foils of an electrode stack before positioning and welding cap plate assemblies over the electrode stack.

Lithium-ion and related batteries are being used in automotive and related transportation applications as a way to supplement, in the case of hybrid electric vehicles (HEVs), or supplant, in the case of purely electric vehicles (EVs), conventional internal combustion engines (ICEs). The ability to passively store energy from stationary and portable sources, as well as from recaptured kinetic energy provided by the vehicle and its components, makes such batteries ideal to serve as part of a propulsion system for cars, trucks, buses, motorcycles and related vehicular platforms. The flow of electric current to and from the individual cells (i.e., a single electrochemical unit) is such that when several such cells are combined into successively larger assemblies (such as modules and packs), the current or voltage can be increased to generate the desired power output. In the present context, larger module and pack assemblies are made up of one or more cells joined in series (for increased voltage), parallel (for increased current) or both, and may include additional structure to ensure proper installation and operation of these cells. One common vehicular form of the battery pack is known as a power battery, while another is known as an energy battery.

In one form, the individual cells that make up a battery pack are configured as rectangular (i.e., prismatic) cans that define a rigid outer housing known as a cell case. These types of cells are generally assembled into the power battery pack variant. Further, these cells may be placed in a facing arrangement (stacked like a deck of cards) along a stacking axis formed by the aligned parallel plate-like surfaces. Positive and negative terminals situated on one edge on the exterior of the housing of each cell are laterally-spaced from one another to act as electrical contacts for connection (via bus bar, for example) to an outside load or circuit. The battery cells may incorporate thin metal sheets as electrode substrates, or simply electrode sheets, to generate the flow of electric current. These electrode sheets incorporate an extension, i.e., foil, which extends outward and is used to join the electrode sheet to conductors or bus bars made of copper metal or metal alloy or aluminum metal or metal alloy during battery assembly. Two types of tab materials are commonly used in battery construction: aluminum and copper.

There is a need for devices and methods for manufacturing or assembling a battery that provides an electrical connection to foils with improved weld porosity, thermal conductivity, electrical conductivity, and tensile strength of foils, and which ensures all the foils are collected and connected. Furthermore, other desirable features and characteristics of the present disclosure will become apparent from the subsequent detailed description and the appended claims, taken in conjunction with the accompanying drawings and the foregoing technical field and background.

### SUMMARY

In an embodiment, a method for manufacturing a battery is provided and includes providing a stack of electrodes, wherein each electrode is electrically connected to a foil; clamping first electrode foils with a first clamp; laser welding the first electrode foils to the first clamp; locating a cap plate over the first clamp; and laser welding the cap plate to the first clamp.

In certain embodiments, the method further includes clamping second electrode foils with a second clamp; laser welding the second electrode foils to the second clamp; and laser welding the cap plate to the second clamp.

In certain embodiments, the method further includes, after clamping the first electrode foils with the first clamp, trimming excess regions of the first electrode foils not clamped by the first clamp; and, after clamping the second electrode foils with the second clamp, trimming excess regions of the second electrode foils not clamped by the second clamp.

In certain embodiments of the method, the cap plate includes a first terminal conductively connected to a first internal terminal plate and a second terminal conductively connected to a second internal terminal plate; laser welding the cap plate to the first clamp includes laser welding the first internal terminal plate to the first clamp; and laser welding the cap plate to the second clamp includes laser welding the second internal terminal plate to the second clamp.

In certain embodiments of the method, the first clamp includes first and second lateral legs; clamping the first electrode foils with the first clamp includes reducing a gap between the first and second lateral legs; the second clamp includes first and second lateral legs; and clamping the second electrode foils with the second clamp includes reducing a gap between the first and second lateral legs.

In certain embodiments of the method, for each clamp, reducing the gap between the first and second lateral legs includes moving at least one of the lateral legs in a first plane.

In certain embodiments of the method, laser welding the first electrode foils to the first clamp includes welding along a first vertical interface perpendicular to the first plane; and laser welding the second electrode foils to the second clamp includes welding along a second vertical interface perpendicular to the first plane.

In certain embodiments of the method, the first clamp includes a first vertical base member having a first inner surface perpendicular to the first plane and perpendicular to the first vertical interface; and the second clamp includes a second vertical base member having a second inner surface perpendicular to the first plane and perpendicular to the second vertical interface.

In certain embodiments of the method, laser welding the cap plate to the first clamp includes welding along the first inner surface; and laser welding the cap plate to the second clamp includes welding along the second inner surface.

In certain embodiments of the method, the cap plate includes a first terminal conductively connected to a first internal terminal plate; laser welding the cap plate to the first clamp includes laser welding the first internal terminal plate to the first clamp; the first clamp includes first and second lateral legs; clamping the first electrode foils with the first clamp includes reducing a gap between the first and second lateral legs by moving at least one of the lateral legs in a first plane; laser welding the first electrode foils to the first clamp includes welding along a first vertical interface perpendicular to the first plane; the first clamp includes a first vertical base member having a first inner surface perpendicular to the first plane and perpendicular to the first vertical interface; and laser welding the cap plate to the first clamp includes welding along the first inner surface.

In another embodiment, a battery assembly is provided and includes first foils associated with first electrodes of a battery cell in a stack; a first clamp having a first lateral leg and a second lateral leg and a vertical base member having a first inner surface, wherein the first foils are located between and welded to the first lateral leg and the second lateral leg; and a cap plate located over the first lateral leg and the second lateral leg and having a first outer side surface, wherein the first outer side surface is welded to the first inner surface.

In certain embodiments of the battery assembly, the cap plate includes a first terminal conductively connected to a first terminal plate, and the first outer side surface is formed by the first terminal plate.

In certain embodiments of the battery assembly, the first foils are welded to the first lateral leg and the second lateral leg by a first weld pool extending in a first vertical direction and in a first lateral direction; and the first outer side surface is welded to the first inner surface by a second weld pool extending in the first vertical direction and in a second lateral direction perpendicular to the first lateral direction.

In certain embodiments of the battery assembly, the first lateral leg and the second lateral leg define a first interface extending in a first vertical direction and in a first lateral direction; and the first outer side surface and the first inner surface define a second interface extending in the first vertical direction and in a second lateral direction perpendicular to the first lateral direction.

In certain embodiments, the battery assembly further includes second foils associated with second electrodes of the battery cell in the stack; and a second clamp having a first lateral leg and a second lateral leg and a vertical base member having a second inner surface, wherein the second foils are located between and welded to the first lateral leg and the second lateral leg; wherein the cap plate has a second outer side surface, and wherein the second outer side surface is welded to the second inner surface.

In another embodiment, a vehicle is provided and includes an electric motor configured to provide motive torque; and a battery system operatively connected to the electric motor and operable to provide electrical power to the electric motor, wherein the battery system includes: first foils associated with first electrodes of a battery cell in a stack; a first clamp having a first lateral leg and a second lateral leg and a vertical base member having a first inner surface, wherein the first foils are located between and welded to the first lateral leg and the second lateral leg; and a cap plate located over the first lateral leg and the second lateral leg and having a first outer side surface, wherein the first outer side surface is welded to the first inner surface.

In certain embodiments of the vehicle, the cap plate includes a first terminal conductively connected to a first terminal plate, and the first outer side surface is formed by the first terminal plate.

In certain embodiments of the vehicle, the first foils are welded to the first lateral leg and the second lateral leg by a first weld pool extending a first vertical direction and a first lateral direction; and the first outer side surface is welded to the first inner surface by a second weld pool extending in the first vertical direction and in a second lateral direction perpendicular to the first lateral direction.

In certain embodiments of the vehicle, the first lateral leg and the second lateral leg define a first interface extending in a first vertical direction and in a first lateral direction; and the first outer side surface and the first inner surface define a second interface extending in the first vertical direction and in a second lateral direction perpendicular to the first lateral direction.

In certain embodiments of the vehicle, the battery system includes second foils associated with second electrodes of the battery cell in the stack; and a second clamp having a first lateral leg and a second lateral leg and a vertical base member having a second inner surface, wherein the second foils are located between and welded to the first lateral leg and the second lateral leg, wherein the cap plate has a second outer side surface, and wherein the second outer side surface is welded to the second inner surface.

### DESCRIPTION OF THE DRAWINGS

The present disclosure will hereinafter be described in conjunction with the following drawing figures, wherein like numerals denote like elements, and wherein:

FIG. 1 is a schematic perspective view of an electric vehicle with a cut-away section to reveal a battery housed in a battery enclosure in accordance with exemplary embodiments.

FIG. 2 is a perspective view of the battery of FIG. 1, in accordance with exemplary embodiments.

FIG. 3 is a flow chart illustrating a method for manufacturing or assembling a battery, in accordance with certain embodiments.

FIG. 4 is a perspective schematic illustrating an electrode stack having electrode foils, during a stage of manufacturing of the method of FIG. 3, in accordance with certain embodiments.

FIG. 5 is a perspective schematic illustrating clamps clamping the electrode foils of FIG. 4, during a subsequent stage of manufacturing of the method of FIG. 3, in accordance with certain embodiments.

FIG. 6 is an overhead schematic of a clamp of FIG. 5 in an initial open configuration, in accordance with certain embodiments.

FIG. 7 is an overhead schematic of a clamp of FIG. 5 in a clamped open configuration, in accordance with certain embodiments.

FIG. 8 is a perspective schematic illustrating clamps welded to electrode foils, during a subsequent stage of manufacturing of the method of FIG. 3, in accordance with certain embodiments.

FIG. 9 is a side view schematic illustrating a cap plate assembly located over and welded to the clamps, during a subsequent stage of manufacturing of the method of FIG. 3, in accordance with certain embodiments.

FIG. 10 is an end view schematic of the cap plate assembly located over and welded to the clamps, during the same stage of manufacturing as FIG. 9, in accordance with certain embodiments.

FIG. 11 is an end view schematic of the battery after the cap plate is sealed to an outer enclosure, during a subsequent stage of manufacturing, in accordance with certain embodiments.

FIG. 12 is an overhead schematic illustrating the use of multiple clamps for each type of electrode foil, during the same stage of manufacturing as FIG. 5, in accordance with certain embodiments.

### DETAILED DESCRIPTION

The following detailed description is merely exemplary in nature and is not intended to limit the application and uses of embodiments herein. Furthermore, there is no intention to be bound by any expressed or implied theory presented in the preceding introduction, summary or the following detailed description.

Embodiments of the present disclosure may be described herein in terms of functional and/or logical block components and various processing steps. Connecting lines shown in the various figures contained herein are intended to represent example functional relationships and/or physical couplings between the various elements. It should be noted that many alternative or additional functional relationships or physical connections may be present in an embodiment of the present disclosure.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

Embodiments herein provide for connecting a stack of electrodes and a battery cap assembly through a first laser welded connections between electrode foils and clamps, and through second laser welded connections between the clamps and the cap plate assembly. Embodiments herein integrate a sandwich strategy for a P-type cell which has electrode foils on a same side. Embodiments herein improve weld porosity, thermal conductivity, electrical conductivity, tensile strength of foils and ensure all the foils are collected and connected.

Embodiments herein provide a new connection of foils to the cap plate assembly. In certain embodiments, the integration of a sandwich internal weld design for P-type foils with a cap plate assembly utilizes a horizontal laser weld strategy. The sandwich weld concept improves thermal conductivity, electrical conductivity, mechanical strength, and collects all the foils for connection.

In certain embodiments, a method includes placing the anode foils in between the anode clamp, and cathode foils in between the cathode clamp; compressing the prongs or legs of the clamps to squeeze the foils together on both the anode and cathode sides; trimming the excess portions of foils that are not clamped; welding the foils to the clamps; aligning each internal terminal plate of the cap plate assembly with a respective clamp; and laser welding the clamps to the respective internal terminal plate.

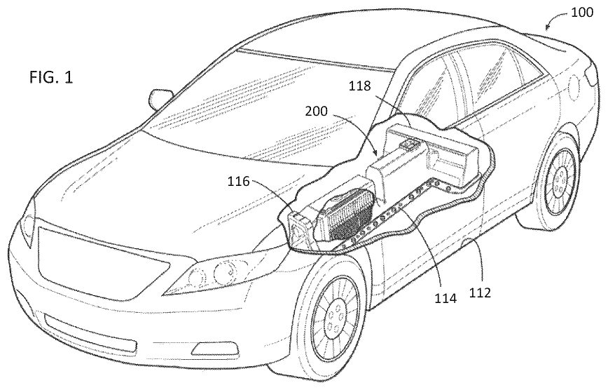

Referring to the drawings, wherein like reference numbers correspond to like or similar components wherever possible throughout the several figures, an electric vehicle 100 having a battery module 200, such as battery cell, or a plurality of battery cells in a battery assembly, is shown in FIG. 1. The term “battery” used alone herein may refer to a battery module, battery cell or cell stack. The term “battery pack” used alone may refer to a battery and the battery enclosure system the battery is housed within.

FIG. 1 illustrates the electric vehicle 100 as an automobile, such as any one of a number of different types of automobiles, such as, for example, a sedan, a wagon, a truck, sport utility vehicle (SUV), or the like. In certain implementations, the vehicle 100 may comprise a motorcycle or other land-based vehicle, such as a rail locomotive, or a non-land-based vehicle such as aircraft, spacecraft, watercraft, and so on, and/or one or more other types of mobile platforms (e.g., a robot and/or another mobile platform). In yet other implementations, the battery module 200 may instead be part of and/or coupled to any number of other types of platforms and/or other systems, moving or non-moving, such as a building, infrastructure, secondary use, home power, non-automotive, and/or other platforms and/or other systems.

The illustrated electric vehicle 100 includes a vehicle chassis 112. The battery module 200 is provided with a battery tray 114. The battery module 200 may attach to the battery tray 114, which in turn, may attach to the vehicle chassis 112 to secure the battery module 200 to the electric vehicle 100.

The electric vehicle 100 may also include a battery disconnect unit 116, which is connected to the battery 200 and provides electrical communication between the battery 200 and an electrical system (not shown) of the electric vehicle 100.

The battery module 200 is further provided with a battery cover 118 that extends over and around the battery 200. The battery cover 118 may protect the battery 200 from being damaged, as well as provide electrical insulation to the high voltage of the battery 200.

In exemplary embodiments, battery module 200 is an assembly of battery cells.

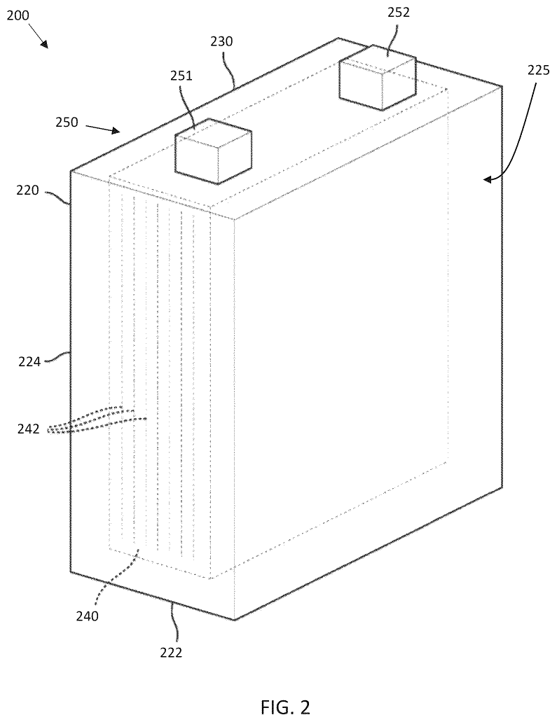

FIG. 2 schematically illustrates in perspective view the battery module 200 of FIG. 1. Specifically, FIG. 2 illustrates the battery module 200 as a prismatic battery 200.

The prismatic battery 200 is illustrated as including an outer case or enclosure 220 that surrounds and defines an internal space 225 within the enclosure 220. An exemplary outer enclosure 220 may be conductive. For example, the outer enclosure 220 may be metallic. In certain embodiments, the enclosure 220 is aluminum. The illustrated outer enclosure 220 is a rectangular polyhedron and includes relatively short side opposite faces 222 and relatively long side opposite faces 224.

As shown, the outer enclosure 220 may be formed with an open end, which is covered or closed by a cap plate 230. In certain embodiments, the cap plate 230 may be part of the enclosure 220. In certain embodiments, the cap plate 230 is conductive. For example, the cap plate 230 may be metallic, such as aluminum or aluminum alloy.

As shown, the battery 200 may include terminals 250, including a first terminal 251, and an optional second terminal 252. Each terminal 251, 252 may be in electrical connection with the battery cell components within the outer enclosure 220. In certain embodiments, each terminal 251, 252 is insulated from the cap plate 230.

In certain embodiments, the battery 200 includes an electrode assembly 240. As shown, the electrode assembly 240 is illustrated with dashed lines, indicating the electrode assembly 240 as a component of the prismatic battery 200 that is internal to the hard outer enclosure 220, i.e., located within the internal space 225. The electrode assembly 240 is illustrated with a plurality of electrode pair layers 242 arranged such that planar surfaces of the electrode pair layers 242 are perpendicular to the short faces 222. The electrode assembly 240 may be referred to as a stack 240 of electrode layers 242.

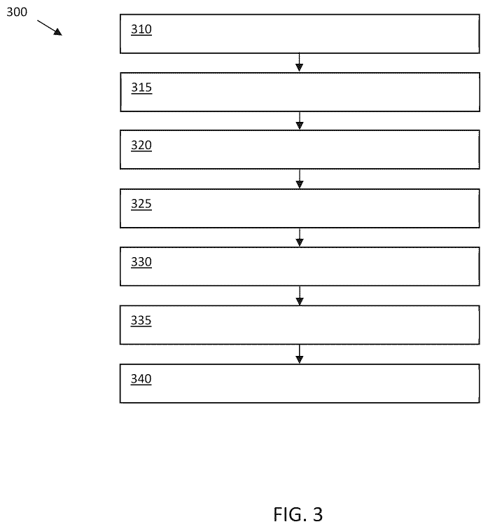

FIG. 3 is a flow chart illustrating a method 300 for manufacturing or assembling a battery, such as the battery 200 of FIG. 2, according to various aspects of the present disclosure.

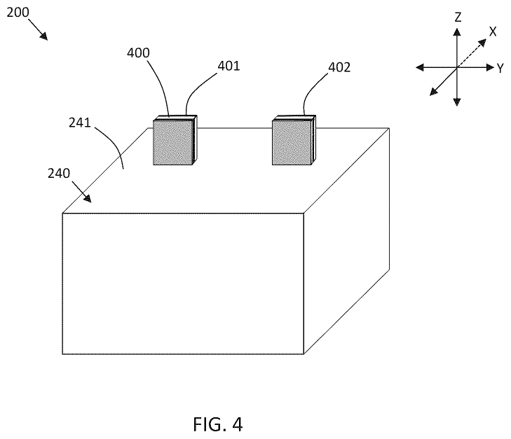

FIG. 3 is described in conjunction with FIGS. 4-11, which the battery 200 or components of the battery 200 at various stages of assembly or manufacture in accordance with some embodiments of the present disclosure of the method 300. The method 300 is merely an example, and is not intended to limit the present disclosure beyond what is explicitly recited in the claims. Additional steps may be provided before, during, and after method 300, and some of the steps described can be moved, replaced, or eliminated for additional embodiments of method 300. Additional features may be added to the battery depicted in the Figures and some of the features described below can be replaced, modified, or eliminated in other embodiments of the battery.

At operation 310, the method 300 provides a stack of electrodes, i.e., an electrode assembly 240, as shown in FIG. 4. FIG. 4 is a schematic perspective view of internal components of a battery 200 during assembly, i.e., the enclosure 220 and cap plate 230 are not illustrated. In FIG. 4, the electrode assembly is generally indicated by reference number 240.

As shown, the electrode assembly 240 is electrically connected to conductive foils 400. Specifically, within the electrode assembly are first electrodes and second electrodes, such as anodes and cathodes. Each first electrode is electrically connected to first foil 401, and each second electrode is electrically connected to a second foil 402. The first foils 401 are spaced from the second foils 402 in the Y-direction as shown. The first foils 401 and second foils 402 are further spaced apart from one another in the X-direction but are gathered together in FIG. 4. While in FIG. 4, the first foils 401 and second foils are located over a same top surface 241 of the electrode assembly 240, embodiments herein are not limited to such a configuration.

In certain embodiments, one of the first and second foils 401 and 402 is aluminum and the other of the first and second foils is copper. Alternatively, other suitable materials may be used to form the firs and second foils 401 and 402.

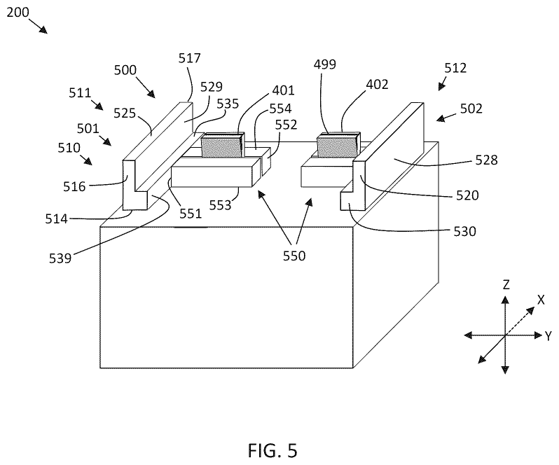

Method 300 continues at operation 320 with clamping the first and second electrode foils with a respective clamp 500, as shown in FIG. 5. For example, a first clamp 501 is used to clamp the first foils 401 and a second clamp 502 is used to clamp the second foils 402. In FIG. 5, the clamps 500 are in a clamped configuration.

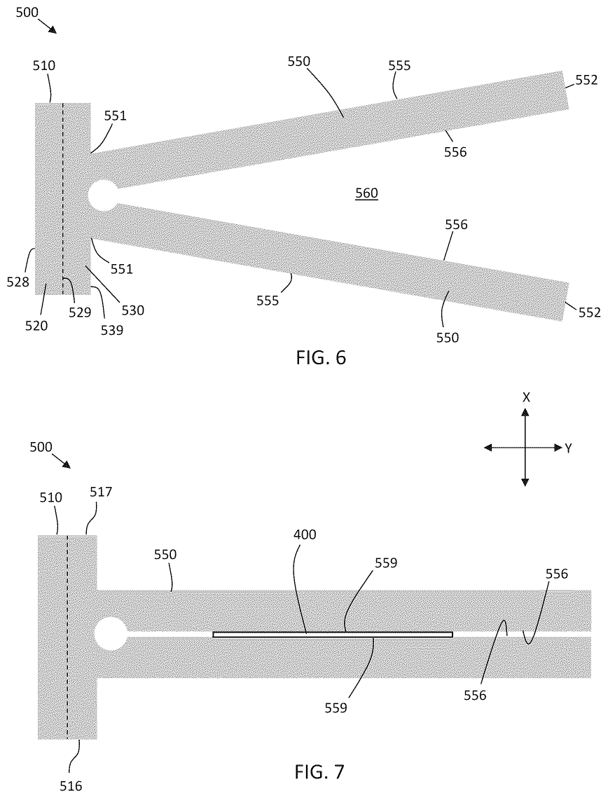

FIGS. 6 and 7 are schematic overhead views of a representative clamp 500, with FIG. 6 illustrating an initial open configuration and FIG. 7 illustrating the clamped configuration. In FIG. 7, a portion of the foils 400 is shown clamped by the clamp 500.

Cross-referencing FIGS. 5-7, each clamp 500 includes a base member 510. The base member 510 may be L-shaped. Specifically, the base member 510 may have an L-shaped first end surface 516 and an L-shaped second end surface 517, and extend longitudinally, i.e., in the X-direction, between the end surfaces 516 and 517.

As shown, the base member 510 may include an outer portion 520 and an inner portion 530. The outer portion 520 and inner portion 530 share a common bottom surface 514 (facing the electrode stack in FIG. 5). Further, the base member 510 extends vertically upward, i.e., in the Z-direction, from the bottom surface 514. Specifically, the outer portion 520 extends vertically upward to an upper surface 525 and the inner portion 530 extends upward to an upper surface 535. The outer portion 520 includes an outer surface 528 and an inner surface 529. The inner portion 530 includes an inner surface 539.

The base member 510 may have an inner vertical height defined as the vertical distance between the bottom surface 514 and the upper surface 535, and an outer vertical height defined as the vertical distance between the bottom surface 514 and the upper surface 525.

Still cross-referencing FIGS. 5-7, each clamp 500 further includes legs 550. In the clamped configuration of FIG. 5 and FIG. 7, the legs 550 are laterally-extending, i.e., extending in the Y-direction, and may be parallel to one another. In the initial open configuration of FIG. 6, the legs 550 may diverge from one another.

As shown in FIGS. 5-7, each leg 550 has a proximal end 551 that is mounted to, or integral with, the respective base member 510. Further, each leg 550 extends away from the respective base member 510 to a distal end 552. As shown, each leg has a bottom surface 553, a top surface 554, an outer side surface 555, and an inner side surface 556.

Each leg 550 may have a vertical height, defined as the distance from the bottom surface 553 to the top surface 554. In certain embodiments, the vertical height of each leg 550 is equal to the inner vertical height of the base member 510.

During operation 315, each clamp 500 is located around the respective foils 400. Specifically, the foils 400 are received in the gap 560 between the inner side surfaces 556 of the legs 550. Then, the gap 560 is reduced, such as by pushing one or both legs 550 toward one another. Such movement is in the X-Y plane.

As a result, the foils 400 are compressed between the inner side surfaces 556 of the respective legs 550. As shown in FIG. 7, the foils 400 contact the inner side surfaces 556 at interfaces 559. Inner side surfaces 556 and interfaces 559 may be vertical, such as co-planer with Y-Z planes. As shown in FIG. 5, excess end portions 499 extend above and away from the clamps 500.

In certain embodiments, first clamp 501 clamps first foils 401, and first clamp 501 and first foils 401 are the same material, and second clamp 502 clamps second foils 402, and second clamp 502 and second foils 402 are the same material. In certain embodiments, first foils 401 and first clamp 501 may be one of copper and aluminum, and second foils 402 and second clamp 502 may be the other of copper and aluminum.

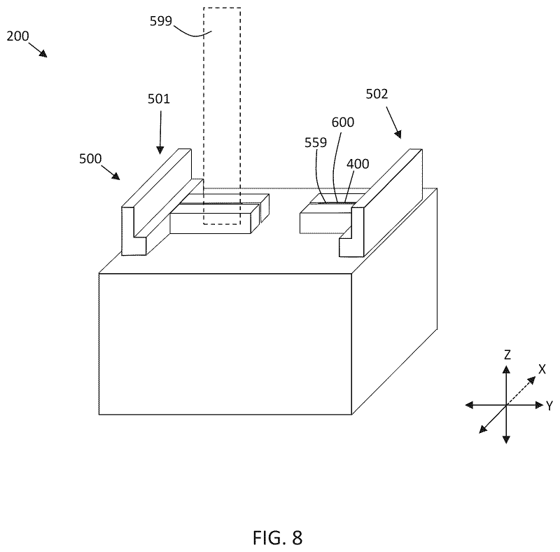

Method 300 may continue at operation 320 with trimming the excess foil 499 not clamped by the clamps 500, as shown in FIG. 8.

Still referring to FIG. 8, method 300 may continue at operation 325 with laser welding the electrode foils 400 to the respective clamps 500. For example, laser welding may be performed along a vertical interface or interfaces 559 perpendicular to the X-Y plane, i.e., in a Y-Z plane 599.

During laser welding, the heated portions of each foil 400 may melt and heated portions of the clamps 500 at the interfaces 559 may melt. After the laser passes, the melted portions solidify and fuse to form a weld nugget 600, such as along the vertical interfaces 559. While melted, the molten portions may travel downward, in the Z-direction, under the force of gravity. Therefore, the weld nuggets may extend to a depth below the deepest focal point of the laser.

With the foils 400 pressed between the opposite inner side surfaces 556 of the respective legs 550, the weld nugget is formed along a vertical Y-Z plane or planes defined by and between the opposite inner side surfaces 556 of the respective legs 550. An exemplary vertical Y-Z plane is indicated by reference number 599.

After welding the foils 400 and respective clamp 500, each welded structure may be referred to as an internal weld plate. In other words, first foils 401 and first clamp 501 form a first internal weld plate, and second foils 402 and second clamp 502 form a second internal weld plate.

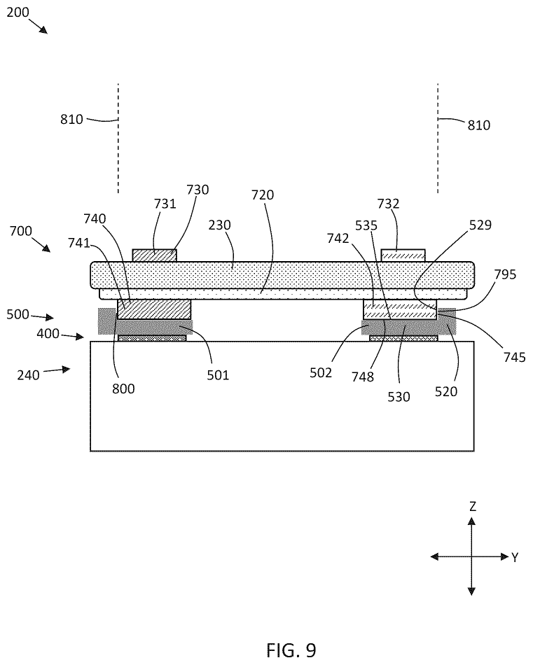

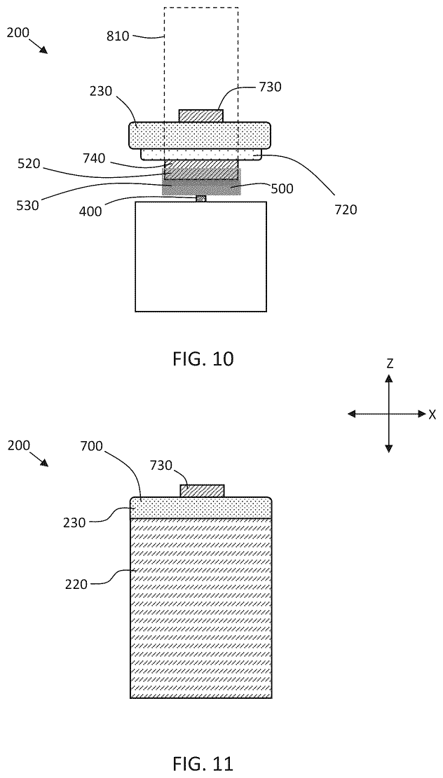

Method 300 may continue at operation 330 with locating a cap plate assembly 700 over the clamps 500, as shown in FIGS. 9 and 10. FIG. 9 provides a side view of the cap plate assembly 700 over the electrode stack 240 and clamps 500 and FIG. 10 provides an end view of the cap plate assembly 700 over the electrode stack 240 and clamps 500.

Cross-referencing FIGS. 9 and 10, the cap plate assembly 700 includes a cap plate 230. Further, the cap plate assembly 700 includes an isolation insert 720 on the underside of the cap plate 230. The cap plate 230 and isolation insert 720 are formed with openings (not shown). Further, the cap plate assembly 700 includes terminals 730, including a first terminal 731 and a second terminal 732. Also, the cap plate assembly 700 includes internal terminal plates 740, including a first internal terminal plate 741 and second internal terminal plate 742.

The terminals 730 are electrically connected to the internal terminal plates 740 through the cap plate 230 and isolation insert 720. Specifically, the first terminal 731 is electrically connected to first internal terminal plates 741, and the second terminal 732 is electrically connected to second internal terminal plates 742.

When the cap plate assembly 700 is located over the clamps 500, the internal terminal plates 740 are aligned with the clamps 500. Specifically, first internal terminal plate 741 is aligned with first clamp 501 and second internal terminal plate 742 is aligned with second clamp 502.

As shown, each internal terminal plate 740 may be received within the outer portions 520 of the clamps 500 and directly over the inner portions 530 of the clamps 500. Each internal terminal plate 740 may have an outer surface 745 in direct contact with the inner surfaces 529 of the outer portions 520 and may have a bottom surface 748 in direct contact with the upper surfaces 535 of the inner portions 530. It is noted that the outer portion 520 is partially transparent in FIG. 10 to allow viewing of the location of the internal terminal plate 740 on the inner portion 530.

Method 300 may continue at operation 335 with laser welding the cap plate assembly 700 to the clamps 500. Specifically, operation 335 may include laser welding the internal terminal plates 740 to the clamps 500. For example, operation 335 includes performing a first process of laser welding the first internal terminal plate 741 to the first clamp 501, and performing a second process of laser welding the second internal terminal plate 742 to the second clamp 502.

Each welding process may be performed along a respective vertical interface 795 formed at or between the respective outer surfaces 745 and the inner surfaces 529. For example, each vertical interface 795 may be co-planar or parallel to the X-Z plane.

During each laser welding process, the laser is focused and at the visible interface 795 between the outer surfaces 745 and the inner surfaces 529, and may be moved from one end surface 516 to the other end surface 517. Heated portions of the clamps 500 and internal terminal plates 740 may melt. After the laser passes, the melted portions solidify and fuse to form a weld nugget 800, such as along the vertical interfaces 795. While melted, the molten portions may travel downward, in the Z-direction, under the force of gravity. Therefore, the weld nuggets may extend to a depth below the deepest focal point of the laser. The weld nuggets are formed along a vertical X-Z plane or planes defined by and between the outer surfaces 745 and the inner surfaces 529. An exemplary vertical X-Z plane is indicated by reference number 810. Each plane 810 is co-planar with or parallel to the X-Y plane.

The laser welding process may be performed with a horizontally applied laser, as described. Alternatively, the assembly may be rotated ninety degrees from the illustrated orientation, such that the laser is applied vertically, i.e., top-down, and the interfaces 795 are oriented horizontally during the welding process.

Method 300 may further include, at operation 340, locating the internal components of the battery 200 within the outer enclosure 220, as shown in the end schematic view of FIG. 11. For example, the cap plate 230 may be sealed to the outer enclosure 220.

While embodiments herein have described a single clamp for each type of electrode foil, i.e., a single first clamp 501 welded to all of the first foils 401, and a single second clamp 502 welded to all of the second foils 402, other embodiments are contemplated.

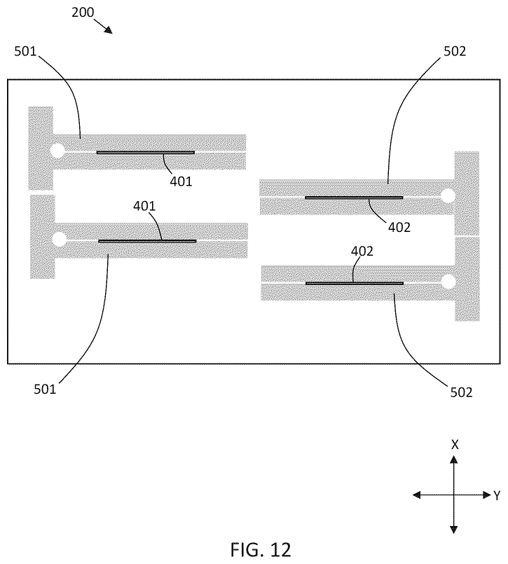

For example, FIG. 12 illustrates an embodiment in which two first clamps 501 are clamped to two separate bundles or stacks of first foils 401 and two second clamps 502 are clamped to two separate bundles or stacks of second foils 402. Other arrangements may be used.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for manufacturing a battery, the method comprising:
providing a stack of electrodes, wherein each electrode is electrically connected to a foil;
clamping first electrode foils with a first clamp;
laser welding the first electrode foils to the first clamp;
locating a cap plate over the first clamp; and
laser welding the cap plate to the first clamp.

2. The method of claim 1, further comprising:
clamping second electrode foils with a second clamp;
laser welding the second electrode foils to the second clamp; and
laser welding the cap plate to the second clamp.

3. The method of claim 2, further comprising:
after clamping the first electrode foils with the first clamp, trimming excess regions of the first electrode foils not clamped by the first clamp; and
after clamping the second electrode foils with the second clamp, trimming excess regions of the second electrode foils not clamped by the second clamp.

4. The method of claim 3, wherein:
the cap plate comprises a first terminal conductively connected to a first internal terminal plate and a second terminal conductively connected to a second internal terminal plate;
laser welding the cap plate to the first clamp comprises laser welding the first internal terminal plate to the first clamp; and
laser welding the cap plate to the second clamp comprises laser welding the second internal terminal plate to the second clamp.

5. The method of claim 4, wherein:
the first clamp includes first and second lateral legs;
clamping the first electrode foils with the first clamp comprises reducing a gap between the first and second lateral legs;
the second clamp includes first and second lateral legs; and
clamping the second electrode foils with the second clamp comprises reducing a gap between the first and second lateral legs.

6. The method of claim 5, wherein, for each clamp, reducing the gap between the first and second lateral legs comprises moving at least one of the lateral legs in a first plane.

7. The method of claim 6, wherein:
laser welding the first electrode foils to the first clamp comprises welding along a first vertical interface perpendicular to the first plane; and
laser welding the second electrode foils to the second clamp comprises welding along a second vertical interface perpendicular to the first plane.

8. The method of claim 7, wherein:
the first clamp includes a first vertical base member having a first inner surface perpendicular to the first plane and perpendicular to the first vertical interface; and
the second clamp includes a second vertical base member having a second inner surface perpendicular to the first plane and perpendicular to the second vertical interface.

9. The method of claim 8, wherein:
laser welding the cap plate to the first clamp comprises welding along the first inner surface; and
laser welding the cap plate to the second clamp comprises welding along the second inner surface.

10. The method of claim 1, wherein:
the cap plate comprises a first terminal conductively connected to a first internal terminal plate;
laser welding the cap plate to the first clamp comprises laser welding the first internal terminal plate to the first clamp;
the first clamp includes first and second lateral legs;
clamping the first electrode foils with the first clamp comprises reducing a gap between the first and second lateral legs by moving at least one of the lateral legs in a first plane;
laser welding the first electrode foils to the first clamp comprises welding along a first vertical interface perpendicular to the first plane;
the first clamp includes a first vertical base member having a first inner surface perpendicular to the first plane and perpendicular to the first vertical interface; and
laser welding the cap plate to the first clamp comprises welding along the first inner surface.

11. A battery assembly comprising:
first foils associated with first electrodes of a battery cell in a stack;
a first clamp having a first lateral leg and a second lateral leg and a vertical base member having a first inner surface, wherein the first foils are located between and welded to the first lateral leg and the second lateral leg; and
a cap plate located over the first lateral leg and the second lateral leg and having a first outer side surface, wherein the first outer side surface is welded to the first inner surface.

12. The battery assembly of claim 11, wherein the cap plate comprises a first terminal conductively connected to a first terminal plate, and wherein the first outer side surface is formed by the first terminal plate.

13. The battery assembly of claim 12, wherein:
the first foils are welded to the first lateral leg and the second lateral leg by a first weld pool extending in a first vertical direction and in a first lateral direction; and
the first outer side surface is welded to the first inner surface by a second weld pool extending in the first vertical direction and in a second lateral direction perpendicular to the first lateral direction.

14. The battery assembly of claim 12, wherein:
the first lateral leg and the second lateral leg define a first interface extending in a first vertical direction and in a first lateral direction; and
the first outer side surface and the first inner surface define a second interface extending in the first vertical direction and in a second lateral direction perpendicular to the first lateral direction.

15. The battery assembly of claim 12, further comprising:
second foils associated with second electrodes of the battery cell in the stack; and
a second clamp having a first lateral leg and a second lateral leg and a vertical base member having a second inner surface;
wherein the second foils are located between and welded to the first lateral leg and the second lateral leg, wherein the cap plate has a second outer side surface, and wherein the second outer side surface is welded to the second inner surface.

16. A vehicle comprising:
an electric motor configured to provide motive torque; and
a battery system operatively connected to the electric motor and operable to provide electrical power to the electric motor, wherein the battery system comprises:
first foils associated with first electrodes of a battery cell in a stack;
a first clamp having a first lateral leg and a second lateral leg and a vertical base member having a first inner surface, wherein the first foils are located between and welded to the first lateral leg and the second lateral leg; and
a cap plate located over the first lateral leg and the second lateral leg and having a first outer side surface, wherein the first outer side surface is welded to the first inner surface.

17. The vehicle of claim 16, wherein the cap plate comprises a first terminal conductively connected to a first terminal plate, and wherein the first outer side surface is formed by the first terminal plate.

18. The vehicle of claim 17, wherein:
the first foils are welded to the first lateral leg and the second lateral leg by a first weld pool extending a first vertical direction and a first lateral direction; and
the first outer side surface is welded to the first inner surface by a second weld pool extending in the first vertical direction and in a second lateral direction perpendicular to the first lateral direction.

19. The vehicle of claim 17, wherein:
the first lateral leg and the second lateral leg define a first interface extending in a first vertical direction and in a first lateral direction; and
the first outer side surface and the first inner surface define a second interface extending in the first vertical direction and in a second lateral direction perpendicular to the first lateral direction.

20. The vehicle of claim 16, wherein the battery system further comprises:
second foils associated with second electrodes of the battery cell in the stack; and
a second clamp having a first lateral leg and a second lateral leg and a vertical base member having a second inner surface;
wherein the second foils are located between and welded to the first lateral leg and the second lateral leg, wherein the cap plate has a second outer side surface, and wherein the second outer side surface is welded to the second inner surface.
